(19) United States
(12) Patent Application Publication
(10) Pub. No.: US 2010/0072231 A1
(43) Pub. Date: Mar. 25, 2010

(54) Baffled Dispensing Closure

(76) Inventors: Kenneth S. Bloom, Bloomdale, OH (US); Karl L. Joseph, Bowling Green, OH (US); Philip D. Bourgeois, Perrysburg, OH (US)

Correspondence Address: REISING, ETHINGTON, BARNES, KISSELLE, P.C., P.O. BOX 4390, TROY, MI, 48099-4390, US

(21) Appl. No.: 12/237,596

(22) Filed: Sep. 25, 2008

(51) Int. Cl. B65D 5/72; B67D 3/00

(52) U.S. Cl. 222/547; 222/546; 222/564

(57) ABSTRACT

A dispensing closure assembly includes a deck having an outlet orifice, and an outlet conduit extending through the deck generally coaxially with respect to the outlet orifice. An inner wall extends generally coaxially with respect to the outlet conduit, wherein a fluid chamber is at least partially defined radially inwardly of the inner wall. A baffle wall is carried radially inwardly of the inner wall, wherein one or more fluid flow passages are defined between the inner wall and the baffle wall. The baffle wall includes a central portion opposed to the outlet conduit and a raised peripheral portion extending axially and radially outwardly from the central portion. Fluid flowing through the fluid flow passages enters the fluid chamber through the fluid flow passages, is directed toward the inner wall by the baffle wall, and then flows into the outlet conduit and out the outlet orifice.

The present disclosure is directed to dispensing closures for fluid products, and to fluid dispensing packages that include such closures.

### BACKGROUND AND OBJECTS OF THE DISCLOSURE

U.S. Pat. No. 6,786,363 discloses a valved dispensing closure, package and method of manufacture in which a flexible resilient valve is positioned within a closure body for securement to a container neck finish. When the container body is squeezed, the central portion of the valve flexes outwardly to dispense fluid product. When the container body is released, the valve closes to shut off flow of fluid product. One or more general objects of the present disclosure, in accordance with one aspect of the disclosure, include providing a dispensing closure assembly, and a package embodying such a closure assembly to reduce or eliminate dispensing of a thinner portion of the liquid product that has separated from a thicker portion of the liquid product, may reduce or eliminate spilling or pre-dispensing of product when a package is inverted or shaken with a lid open, and/or may automatically remove product from a dispensing orifice when a container is released.

The present disclosure embodies a number of aspects that can be implemented separately from or in combination with each other.

A dispensing closure assembly in accordance with one aspect of the disclosure includes a deck having an outlet orifice, and an outlet conduit extending through the deck generally coaxially with respect to the outlet orifice. The assembly also includes an inner wall extending generally coaxially with respect to the outlet conduit, wherein a fluid chamber is at least partially defined radially inwardly of the inner wall. The assembly further includes a baffle wall carried radially inwardly of the inner wall, wherein one or more fluid flow passages are defined between the inner wall and the baffle wall. The baffle wall includes a central portion opposed to the outlet conduit and a raised peripheral portion extending axially and radially outwardly from the central portion. Fluid flowing through the fluid flow passages enters the fluid chamber through the fluid flow passages, is directed toward the inner wall by the baffle wall, and then flows into the outlet conduit and out the outlet orifice.

In accordance with another aspect of the disclosure, there is provided a dispensing closure assembly that includes a base having a skirt with a longitudinal axis, an opening remote from the skirt, and an inner wall extending inwardly from an inner periphery of the opening. The base also includes a baffle wall carried at an inner end of the inner wall and connected to the inner end of the inner wall by connecting elements such that fluid flow passages are formed between the connecting elements, the inner end of the inner wall and an outer periphery of the baffle wall. The assembly also includes a closure secured to the base and overlying the opening, and having a deck overlying the opening. The closure also has an outlet orifice in the deck, and an outlet conduit extending through the deck coaxially with the inner wall of the base, wherein a fluid chamber is defined radially inwardly of the inner wall. Fluid flowing between the connecting elements enters the fluid chamber and then flows into the outlet conduit and out the outlet orifice.

In accordance with a further aspect of the disclosure, there is provided a dispensing closure assembly that includes a closure base including an opening, an outer wall extending axially inwardly and tapering radially outwardly, and an inner wall extending axially inwardly and terminating in an inner end carrying a baffle wall and including fluid flow passages. The assembly also includes a closure including a collar coupled to the closure base and having a transversely extending deck with an outlet orifice and also having an orifice tube outlet conduit in communication with the outlet orifice and extending axially toward the baffle wall of the closure base and terminating in an open end spaced from the baffle wall. A fluid chamber is defined between the orifice tube outlet conduit and the inner wall of the closure base. Product being dispensed flows through the fluid flow passages and enters the fluid chamber before flowing into the orifice tube outlet conduit and out the outlet orifice.

In accordance with an additional aspect of the disclosure, there is provided a dispensing closure assembly that includes a closure base including a deck having an outlet orifice, an orifice tube outlet conduit extending from the deck generally coaxially with respect to the outlet orifice, and an inner wall extending from the deck generally coaxially with respect to the orifice tube outlet conduit wherein a fluid chamber is at least partially defined between the orifice tube outlet conduit and the inner wall. The assembly also includes a baffle coupled to the closure base and including a baffle wall carried radially inwardly of the inner wall, wherein one or more fluid flow passages are defined between the inner wall and the baffle wall, the baffle wall including a central portion opposed to the orifice tube outlet conduit and a raised peripheral portion extending axially and radially outwardly from the central portion. Fluid flowing through the fluid flow passages enters the fluid chamber through the fluid flow passages, is directed toward the inner wall by the baffle wall, and then flows into the orifice tube outlet conduit and out the outlet orifice.

### BRIEF DESCRIPTION OF THE DRAWINGS

The disclosure, together with additional objects, features, advantages and aspects thereof, will be best understood from the following description, the appended claims and the accompanying drawings, in which:

FIG. 1 is a side elevational view of a dispensing package in accordance with an exemplary embodiment;

FIG. 2 is a fragmentary sectional view diametrically bisecting the package of FIG. 1 along line 2-2, and partially illustrating a dispensing closure assembly;

FIG. 3 is a fragmentary sectional view on an enlarged scale of a portion of the closure assembly illustrated in FIG. 2;

FIG. 4A is a top perspective view of the closure assembly illustrated in FIG. 2, illustrating a lid in an opened position;

FIG. 4B is a top perspective view of the closure assembly illustrated in FIG. 4A, illustrating the lid in a closed position;

FIG. 5 is bottom perspective view of the closure assembly illustrated in FIG. 2;

FIG. 6 is an exploded elevational view of the closure assembly in the exemplary embodiment of FIGS. 1-5;

FIG. 7 is a top plan view of a closure of the closure assembly of FIG. 4A;

FIG. 8 is a sectional view taken substantially along the line 8-8 in FIG. 7;

FIG. 9 is a top plan view of a closure base of the closure assembly of FIG. 6, with the closure removed;

FIG. 10 is a sectional view taken substantially along the line 10-10 in FIG. 9;

FIG. 11 is a fragmentary view taken substantially along the line 11-11 in FIG. 5;

FIG. 12 is a perspective view of a dispensing closure assembly in accordance with another exemplary embodiment;

FIG. 13 is a cross-sectional view of the dispensing closure assembly of FIG. 12, illustrating a baffle carried by a closure base;

FIG. 14 is a bottom view of the baffle of FIG. 13;

FIG. 15 is a top view of the baffle of FIG. 13;

FIG. 15A is a cross-sectional view of the baffle of FIG. 13, taken along line 15A-15A of FIG. 14;

FIG. 15B is a cross-sectional view of the baffle of FIG. 13, taken along line 15B-15B of FIG. 14;

FIG. 16 is a perspective view of a dispensing closure assembly in accordance with yet another exemplary embodiment;

FIG. 17 is a cross-sectional view of the dispensing closure assembly of FIG. 16, illustrating the baffle of FIGS. 12-15B carried by a closure base;

FIG. 18 is a perspective view of a dispensing closure assembly in accordance with still another exemplary embodiment; and

FIG. 19 is a cross-sectional view of the dispensing closure assembly of FIG. 18, illustrating the baffle of FIGS. 12-15B carried by a closure base.

### DETAILED DESCRIPTION OF PREFERRED EMBODIMENTS

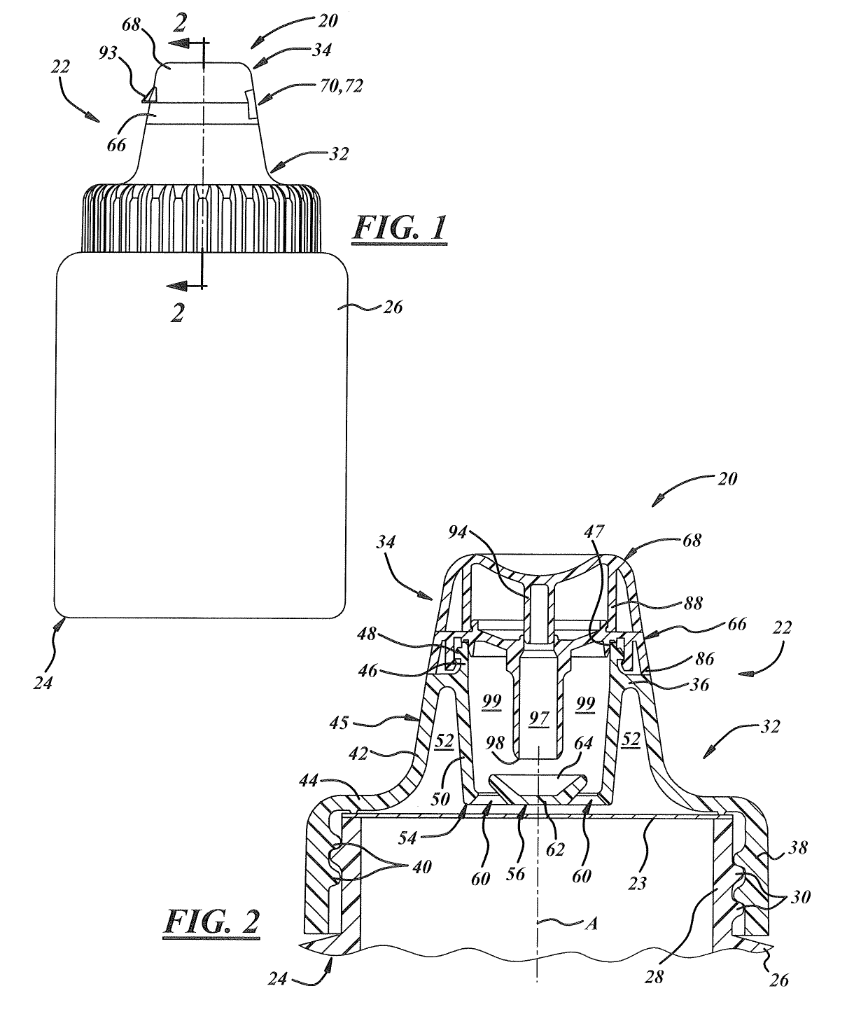

FIGS. 1 and 2 illustrate a dispensing package 20 in accordance with one presently preferred embodiment of the disclosure as comprising a baffled dispensing closure assembly 22 secured to a container 24. The package 20 maybe used to contain and dispense any suitable product, for example, fluid product such as beverages, body lotions, and food condiments such as ketchup or mustard. The package 20 generally extends along a longitudinal axis A (FIG. 2).

The container 24 maybe of one-piece integrally molded plastic construction and may be composed of any suitable container material compatible with the product to be contained. The container 24 has a flexible resilient body 26 for holding product to be dispensed and for being squeezed from its state of rest to dispense product and released from its squeezed state to automatically return to its state of rest to withdraw residual product back into the container 24. As shown in FIG. 2, a cylindrical neck finish 28 (FIG. 2) extends from the body 26 and surrounds and defines a container mouth. The neck finish 28 may include one or more engagement elements, for example, external beads or threads 30 for securing the closure assembly 22 to the container 24. As used herein, the term threads includes one or more threads or thread segments that may be continuous or discontinuous and may or may not extend around the entire circumference of the neck finish 28.

As shown in FIGS. 1 and 2, the closure assembly 22 generally includes a closure base 32 and a closure 34 coupled or secured to the closure base 32. Each of the closure base 32 and the closure 34 may be of one-piece integrally molded plastic construction and may be composed any suitable closure materials compatible with the product to be dispensed. For example, the closure base 32 and closure 34 may be composed of polypropylene.

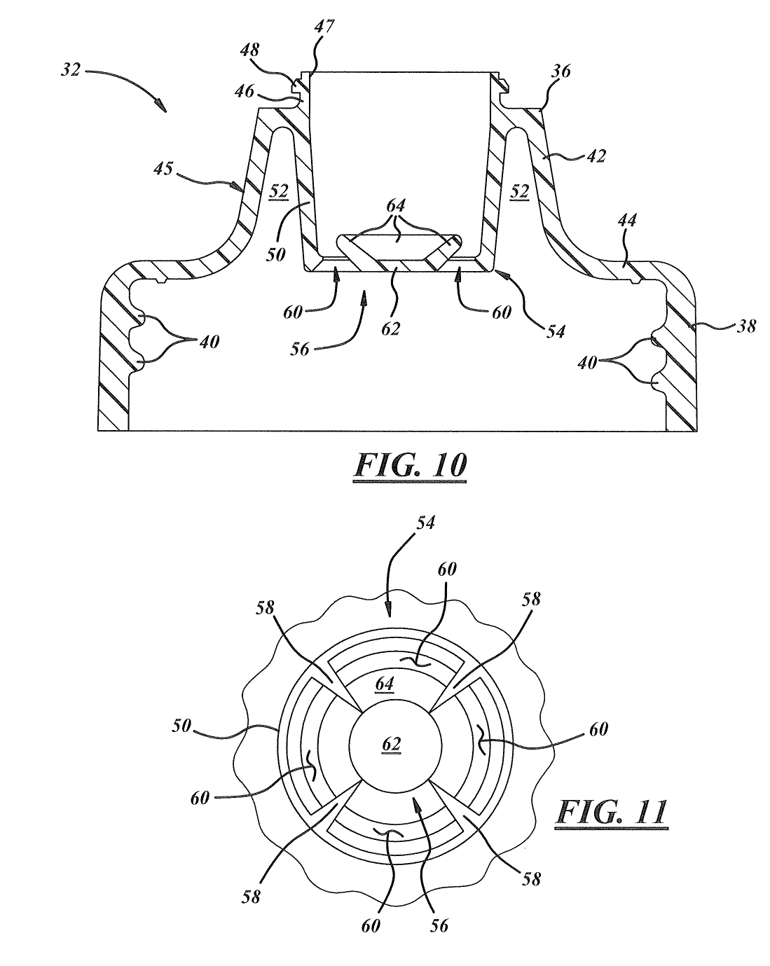

Referring to FIG. 10, the closure base 32 may include a flat axially facing annular plateau or transversely extending base wall 36 from which a peripheral skirt 38 ultimately may depend in a generally axial direction and coaxial with the container neck finish 28 (FIG. 1). As used herein, the terminology transverse includes being disposed at any angle with respect to an axis including, but not limited to, a perpendicular orientation. The skirt 38 may have one or more engagement elements, for example, continuous or segmented internal threads or beads 40 for cooperating with the external threads or beads 30 on the container neck finish 28 (FIG. 1) to secure the closure assembly 22 thereto. The skirt 38 may be connected to the base wall 36 by an outer wall 42 that may be conical and may extend generally axially inwardly or downwardly and radially outwardly from the base wall 36, and by a generally flat base 44 that may extend radially outwardly from a lower end of the conical wall 42 to an upper end of the peripheral skirt 38. (Directional words such as “upper” and “lower” are used by way of description and not limitation with respect to the upright orientation of the closures and packages illustrated in the drawings. Directional words such as “axial,” “radial” and “lateral” are taken with respect to the longitudinal axis of the closure, which is preferably coaxial with the axis of the container neck finish. Directional words such as “inwardly” and “outwardly” are taken with respect to the package interior.)

The base wall 36, the conical outer wall 42, and an annular wall 46 extending axially from the base wall 36 may at least partially define a spout 45 of the closure base 32. As will be described in detail below, other embodiments need not include a spout-type closure. The annular wall 46 may extend axially outwardly or upwardly from the base wall 36 coaxially with the skirt 38 and may terminate in an opening 47 of the spout 45 at an upper end thereof remote from the skirt 38. An annular bead 48 of the annular wall 46 may surround and extend radially outwardly from the cylindrical wall 46 at a position spaced from the upper end of the annular wall 46. The bead 48 may be circumferentially continuous or segmented.

An inner wall 50 may be annular and conical and may extend axially downwardly from an inner periphery of the opening 47 in the base wall 36 and coaxially with the spout 45. Thus, the inner wall 50 may form a continuation of the annular wall 46 disposed radially inwardly of the conical outer wall 42. The inner wall 50 may, as illustrated in FIG. 2, taper axially and radially inwardly away from the conical outer wall 42 and the annular wall 46 and terminate in a free, inner end 54. A well or chamber 52 may be defined between the conical outer wall 42 and the inner wall 50, and may include an annular anti-syneresis well. As used herein, the term syneresis may include separation of a thinner portion of a liquid from a thicker portion of the liquid. Accordingly, one exemplary use for the chamber 52 may be to collect any separated thinner portion of a liquid product and prevent it from being dispensed separately from the thicker portion of the liquid product.

The closure base 32 of the dispensing closure assembly 22 (FIG. 1) may be baffled. For example, a baffle of the closure base 32 may include a baffle wall 56 carried by the inner wall 50. More specifically, the baffle wall 56 maybe coupled to the inner end 54 of the inner wall 50 by one or more connecting elements 58 (FIG. 11). The connecting elements 58 may include straps or spokes that may extend in a generally radially direction, or any other suitable structure to connect the baffle wall 56 to the inner wall 50 so as to at least partially define fluid flow passages 60 between the connecting elements 58, the inner wall 50, and an outer periphery of the baffle wall 56. The baffle wall 56 may have a central portion 62 and an angled or raised peripheral portion 64 that may extend generally axially and radially outwardly from the central portion 62, for example, to define the baffle wall 56 in a bowl shape. The peripheral portion 64 may have straight angled sides as shown, and/or may have curved sides. The central portion 62 may be a generally planar structure as shown or may also represent a vertex of the raised peripheral portion 64. Also, as shown, the inner end 54 maybe chamfered. The chamfer angle of the inner end 54 of the annular wall 50 and/or the angle of the raised peripheral portion 64 may provide a generous lead-in feature to reduce the force applied to the container body 26 to actuate the package 20 and to aid in dispensing product therefrom. Such angle(s) may be of any suitable magnitude, for example, from 20 to 70 degrees from horizontal.

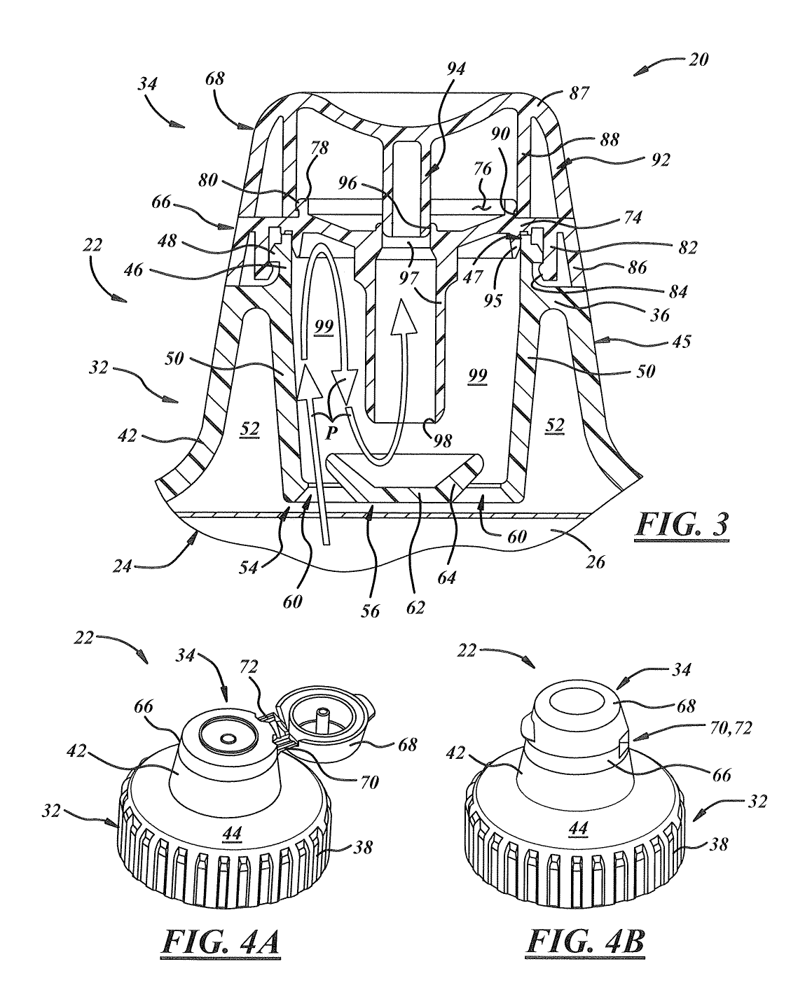

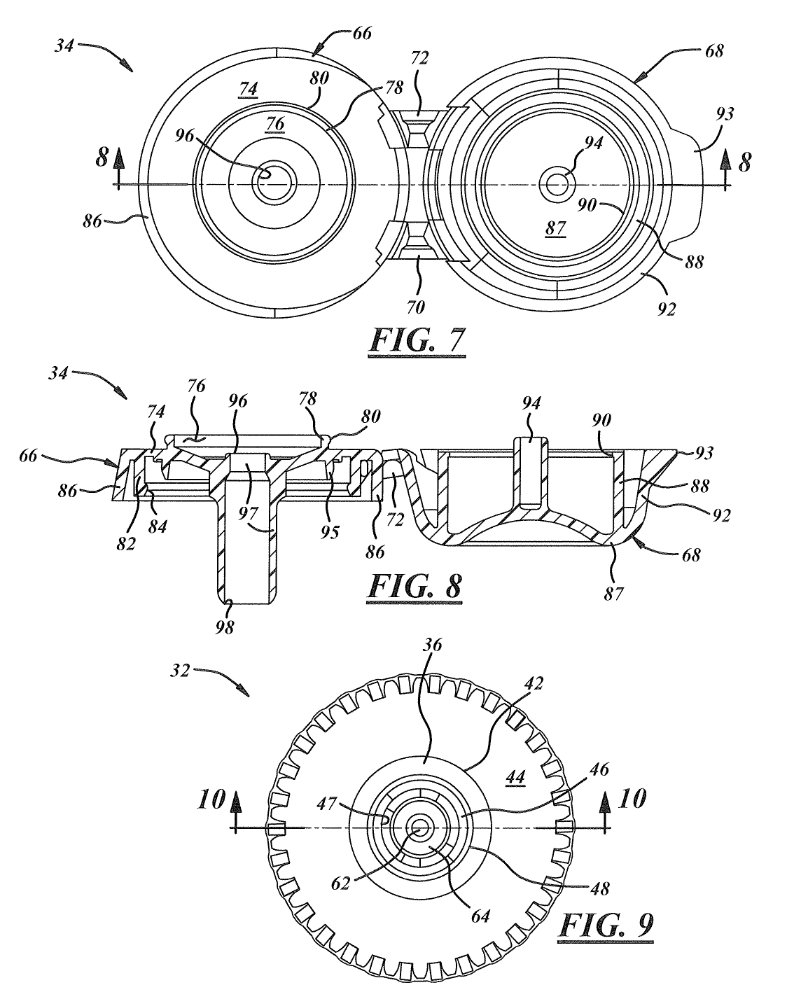

Referring to FIG. 3, the closure 34 maybe secured to the closure base 32 at the upper end of the spout 45 and may overlie the opening 47 thereof. The closure 34 may include a collar 66 coupled to the closure base 32 and a lid 68 that may be integrally coupled to the collar 66, for example, by one or more hinges such as laterally spaced snap hinges 70, 72, which are best shown in FIG. 7. For example, the snap hinges 70, 72 may be of the type illustrated in U.S. Pat. Nos. 5,794,308 and 6,041,477. The illustrated hinge configuration is exemplary only, and other hinge configurations could be employed.

Referring to FIGS. 3 and 8, the collar 66 may have a transversely extending deck 74 to overlie the spout opening 47 (FIG. 2) and may have a central opening 76 to generally align in assembly with the spout opening 47 (FIG. 2). A first cylindrical wall 78 may surround or define the opening 76 and may extend axially upwardly or outwardly from the deck 74—i.e., in a direction away from the mouth of the container 26 (FIG. 1). A circumferentially continuous or segmented bead 80 may extend around the cylindrical wall 78 radially outwardly from the opening 76. A second cylindrical wall 82 may extend inwardly or downwardly from the deck 74, generally coaxially with the cylindrical wall 78 and the longitudinal axis A of the package 20. The second cylindrical wall 82 may have a segmented or continuous internal bead 84 that may be received over the bead 48 on the annular wall 46 of the base 32 for securing the collar 66 of the closure 34 to the closure base 32.

Referring to FIG. 3, a conical outer wall 86 of the collar 66 may extend to the base wall 36 of the base 32. Also, a radially outer surface of the conical wall 86 may blend with and form a continuation of an outer surface of the conical wall 42 of the base 32 to provide the appearance of a continuous conical wall surface along the collar 66 and the base 32.

Referring to FIGS. 3 and 8, the lid 68 may include a base wall 87, and an inner cylindrical wall 88 extending from the base wall 87. The cylindrical wall 88 may have a circumferentially continuous or segmented radially inwardly extending bead 90 for receipt over the bead 80 on the collar wall 78 to removably secure the lid 68 in the closed position illustrated in FIGS. 1-3.

Referring to FIG. 3, the lid 68 also may include a conical outer wall 92 that may extend to the collar deck 74 in the closed position of the lid 68. The outer wall 92 may have a conical outer surface that may blend with and form a continuation of the conical outer surfaces of the conical wall 42 of the base 32 and the conical wall 86 on the collar 66 to provide an overall continuous conical wall surface appearance to the closure 34 in the closed position of the lid 68. Referring to FIGS. 7 and 8, a lug 93 may project from the lid wall 92 opposite of the hinges 70, 72 to facilitate opening of the lid 68. The lid 68 also may include a plug 94 for sealing with the collar 66 as will be described in greater detail below.

Referring again to FIG. 3, the collar 66 also may include a sealing wall 95 depending in a generally axial direction from the collar deck 74 for sealing engagement with the opening 47 of the spout 45. The deck 74 may extend generally radially and axially inwardly from the walls 78, 95, and may include an outlet orifice 96 in an outer surface of the deck 74. The plug 94 of the lid 68 may sealingly engage the collar 66 within the outlet orifice 96 of the collar 66 when the lid 68 is closed.

The collar 66 further may include an outlet conduit 97 extending through the deck 74. In one embodiment, the outlet conduit 97 may merely include a passage in the deck 74 in communication with the outlet orifice 96 in the deck 74. In another embodiment, the outlet conduit 97 may further include an orifice tube that may extend generally axially inwardly from the deck 74 in communication with the outlet orifice 96 in the deck 74 and coaxially with the inner wall 50 of the closure base 32. In the latter embodiment, the orifice tube outlet conduit 97 may terminate in an inlet 98 spaced from and facing the baffle wall 56. The tube outlet conduit 97 may correspond with the central portion 62 of the baffle wall 56, for example, such that the tube outlet conduit 97 may be generally opposed to the central portion 62 of the baffle wall 56 or axially aligned with the central portion 62. An inner diameter of the tube outlet conduit 97 at the inlet 98 may be less than an outer diameter of the baffle wall 56 of the closure base 32.

Finally, a fluid chamber 99 may be at least partially defined radially inwardly of the inner wall 50, and may be of any suitable shape and size. More particularly, the fluid chamber 99 may be further defined as space between the deck 74 and downstream of the fluid flow passages 60. In a specific example, the fluid chamber 99 may be defined radially between the inner wall 50 and the tube outlet conduit 97 in the orifice tube embodiment. The tube outlet conduit 97 may be of any shape and may, for example, extend greater than half of the axial length of the fluid chamber 99.

In one example of use, and referring to FIG. 2, the container 24 is filled with product to be dispensed with the closure assembly 22 removed. The closure assembly 22, which may be assembled separately, is then secured to the container neck finish 28. A removable sealing liner 23 may be placed over the open end or mouth of the container neck finish 28 or within the closure skirt 38 prior to securement of the closure assembly 22 to the container neck finish 28. The liner 23 may comprise a layered construction, having an underlayer of plastic and a layer of metal foil, for example. The metal foil may be heated by induction to melt at least peripheral portions of the plastic layer to secure the liner 23 to the end of the container neck finish 28.

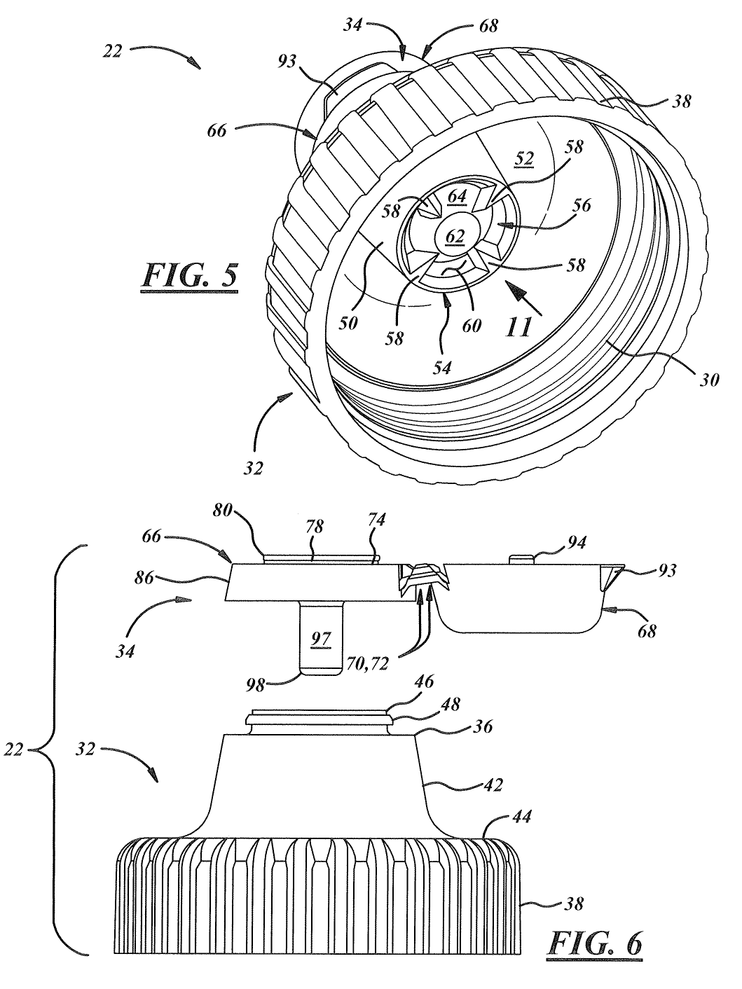

When the package 20 is ready for dispensing of the product by a user, the closure assembly 22 is removed by the user and the liner 23 is cut or peeled away from the container neck finish 28. The closure assembly 22 is then resecured to the container neck finish 28. With the closure lid 68 pivoted to the open position (FIG. 4A), the package 20 may be shaken to prepare the product for dispensing. Shaking of the package 20 does not result in spillage or ejection of product because of the baffle and outlet conduit configuration. Also, the package 20 may be inverted in preparation for dispensing, wherein any thinner portion of the product that has separated from a thicker portion of the product tends to collect in the anti-syneresis well 52 and, thus, gets trapped from being dispensed. The user may squeeze the container body 26 to move product through the fluid flow passages 60 between the baffle wall connecting elements 58 (FIGS. 5 and 11), wherein the raised peripheral portion 64 directs product toward the inner wall 50.

As shown in FIG. 3, product being dispensed may follow a convoluted path P through the closure base 32. In any event, product enters the fluid chamber 99 flowing toward and along the inner wall 50 and may flow around the tube outlet conduit 97. Product continues to enter the fluid chamber 99 at least until the level of the product reaches the inlet opening 98. Product flows into the tube outlet conduit 97 and to and through the outlet orifice 96.

When the desired amount of product has been dispensed, the container body 26 may be released. The vacuum produced by the container body 26 returning to its original shape is greater than the force of gravity on the product, such that some product is withdrawn or pulled back through the tube outlet conduit 97 toward the container 24 for a clean shut-off of product and a clean outlet orifice 96. The lid 68 may be closed and snapped over the collar 66, such that the plug 94 seals within the outlet orifice 96 and prevents dispensing of product in the event that the container body 26 is squeezed by a user with the lid 68 closed.

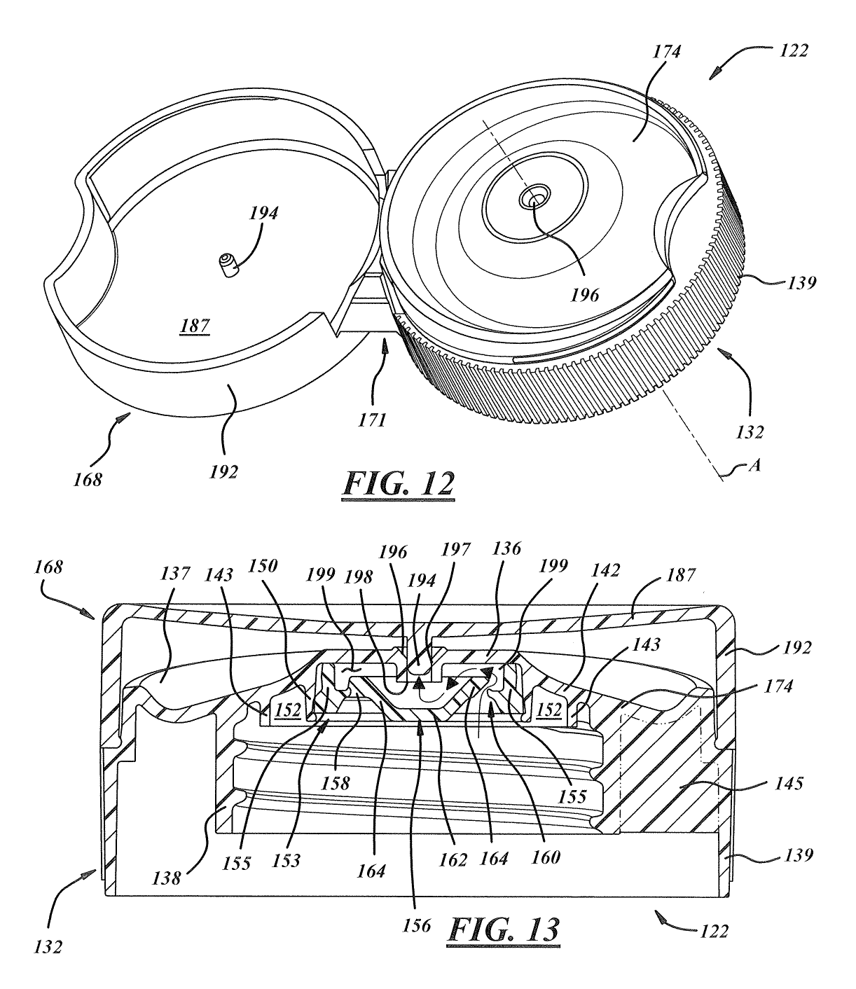

FIGS. 12 through 15B illustrate another exemplary embodiment of the present disclosure. This embodiment is similar in many respects to the embodiment of FIGS. 1 through 11 and like numerals between the embodiments generally designate like or corresponding elements throughout the several views of the drawing figures. Additionally, the descriptions of the embodiments are incorporated by reference into one another and the common subject matter generally may not be repeated here.

As shown in FIGS. 12 and 13, a closure assembly 122 may include a base 132 and a lid 168 coupled to the base 132, for example, by a hinge 171, which may include one or more snap hinges, or any other suitable closure hinge. The base 132 generally may include an outer skirt 139 that may define a longitudinal axis A of the base 132, and a deck 174 that may extend transversely with respect to the axis A. An outlet orifice 196 may extend through a portion of the deck 174. The lid 168 generally may include a base wall 187 having a plug 194 for plug sealing engagement with the outlet orifice 196 of the base, and a skirt 192 depending generally axially from the base wall 187.

Referring now to FIG. 13, the deck 174 may include a substantially planar and axially oriented plateau 136 in which the outlet orifice 196 is disposed, a sloped wall 142 extending radially outwardly from the plateau 136, and a rim 137 extending axially from the sloped wall 142. The base 132 may also include an inner skirt 138 for coupling to a neck finish of a container (not shown), and a sealing wall 143 for sealing within an open mouth of the neck finish (not shown). The base 132 may further include an inner wall 150 that may be annular and may extend axially from the deck 174, and a chamber 152, such as an anti-syneresis well, may be defined between the conical sealing wall 143 and the inner wall 150. The base 132 may additionally include web walls 145 to connect the inner and outer skirts 138, 139. In one embodiment, the base 132 may include an outlet conduit 197 extending through the deck 174 in communication with the outlet orifice 196. In another embodiment, as shown in FIG. 13, the outlet conduit 197 may also include an orifice tube extending inwardly from the deck 174.

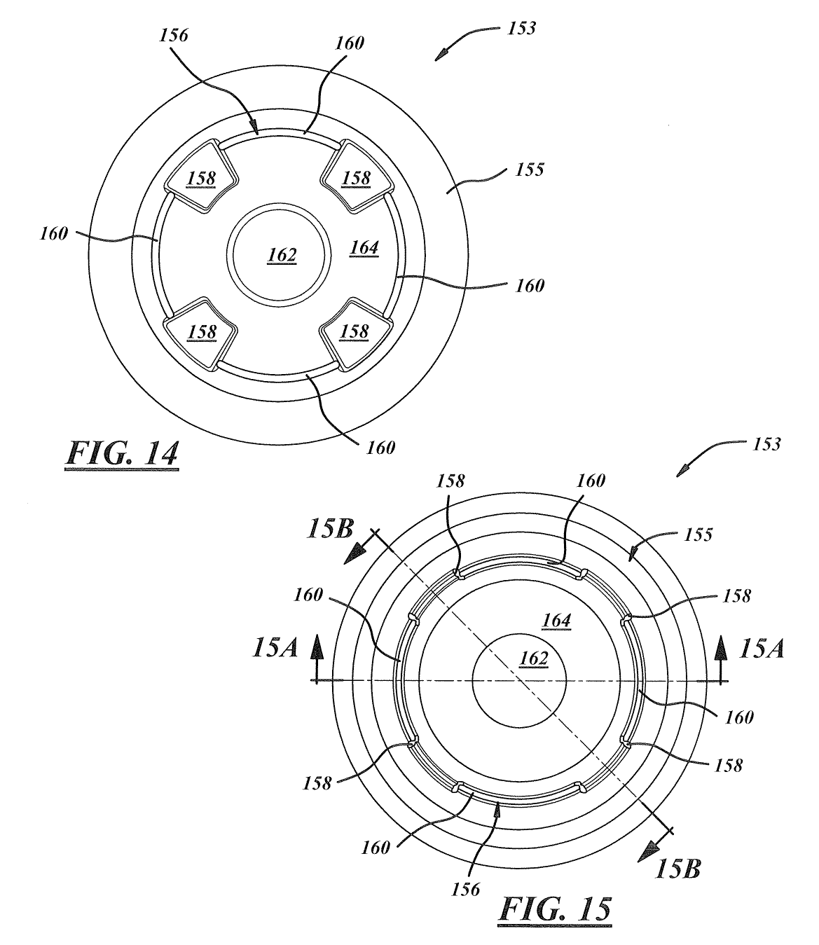

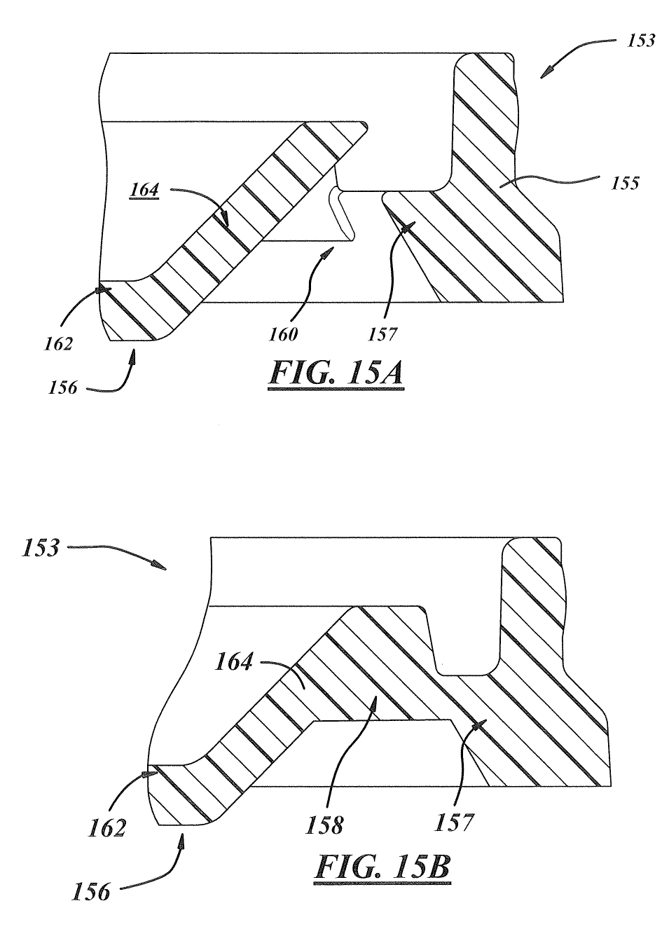

The closure assembly 122 may also include a baffle 153 carried by the base 132 in any suitable manner. For example, the baffle 153 may be a separate component that may be fit within the inner wall 150 in any suitable fashion. In more particular examples, the baffle 153 may be press fit to the inner wall 150 to frictionally retain the baffle 153 to the base 132, and/or may be snap fit to the inner wall 150 in any suitable manner. With additional reference to FIGS. 14 and 15, the baffle 153 may include an annular wall 155 corresponding to the inner wall 150 of the base 132, a baffle wall 156 to baffle or divert fluid flow, and one or more straps or connecting elements 158 to couple the baffle wall 156 to the annular wall 155. In another embodiment, the annular wall 155 may be coupled directly to the deck 174 (FIG. 13) in any suitable manner such that the annular wall 155 replaces, or is one and the same as, the inner wall 150. The baffle wall 156 may include a central portion 162 and a raised peripheral portion 164. Fluid flow passages 160 may be formed between the inner wall 150 (FIG. 13) and the baffle wall 156. More specifically, the passages 160 may be formed between the outer wall 155 of the baffle 153 and an outer periphery of the baffle wall 156. As shown in FIGS. 15A and 15B, the outer wall 155 may include an annular projection 157 extending radially inwardly for connection to the straps 158 and having an angled surface to provide a lead-in feature.

Referring to FIG. 13, a fluid chamber 199 may be defined radially inwardly of the inner wall 150. More particularly, the fluid chamber 199 maybe defined between the inner wall 150 and the orifice tube outlet conduit 197 extending coaxially with respect to the outlet orifice 196 from the deck 174 of the base 132. The tube outlet conduit 197 may extend in an axially direction to such an extent that there is overlap in an axial direction between an inlet end 198 of the tube 197 and the raised peripheral portion 164 of the baffle wall 156.

Accordingly, when product is dispensed through the closure 122, the product may follow a convoluted path (as shown by the arrows). More specifically, product may enter the fluid chamber 199 through the openings 160 and may be directed by the baffle wall 156 toward the inner wall 150 and around the tube outlet conduit 197. Product may continue to enter the chamber 199 until the level of the product reaches the inlet opening 198. Product flows into the tube outlet conduit 197 and to and through the outlet orifice 196.

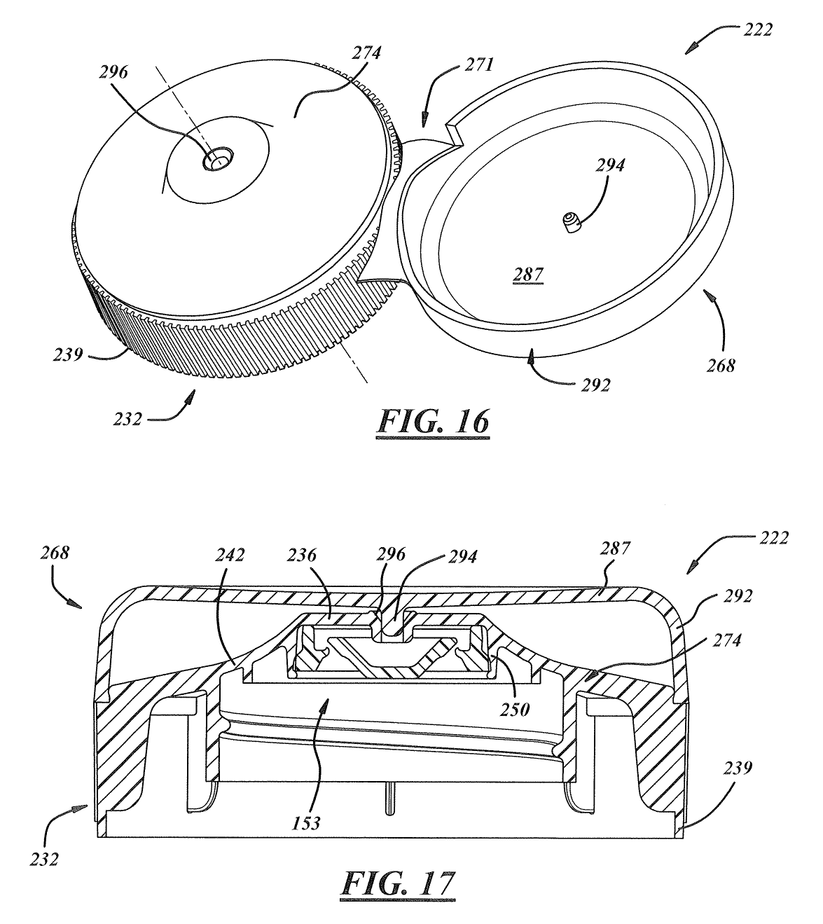

FIGS. 16 and 17 illustrate yet another exemplary embodiment of the present disclosure. This embodiment is similar in many respects to the embodiment of FIGS. 1 through 15B and like numerals between the embodiments generally designate like or corresponding elements throughout the several views of the drawing figures. Additionally, the descriptions of the embodiments are incorporated by reference into one another and the common subject matter generally may not be repeated here.

In particular, the embodiment of FIGS. 16 and 17 is substantially similar to that of FIGS. 13 through 15B, except, for example, the rim 137 of FIGS. 13 and 14 is omitted. As shown in FIGS. 16 and 17, a closure assembly 222 may include a base 232 and a lid 268 coupled to the base 232, for example, by a hinge 271, which may include, for example, a butterfly type of hinge, or any other suitable closure hinge. The base 232 generally may include an outer skirt 239 that may define a longitudinal axis A of the base 232, and a deck 274 that may extend transversely with respect to the axis A. An outlet orifice 296 may extend through a portion of the deck 274. The lid 268 generally may include a base wall 287 having a plug 294 for plug sealing engagement with the outlet orifice 296 of the base, and a skirt 292 depending generally axially from the base wall 287. Referring now to FIG. 17, the deck 274 may include a substantially planar and axially oriented plateau 236 in which the outlet orifice 296 is disposed, and a sloped wall 242 extending radially outwardly from the plateau 236. The base 232 may further include an inner wall 250 that may be annular and may extend axially from the deck 274 to carry the baffle 153.

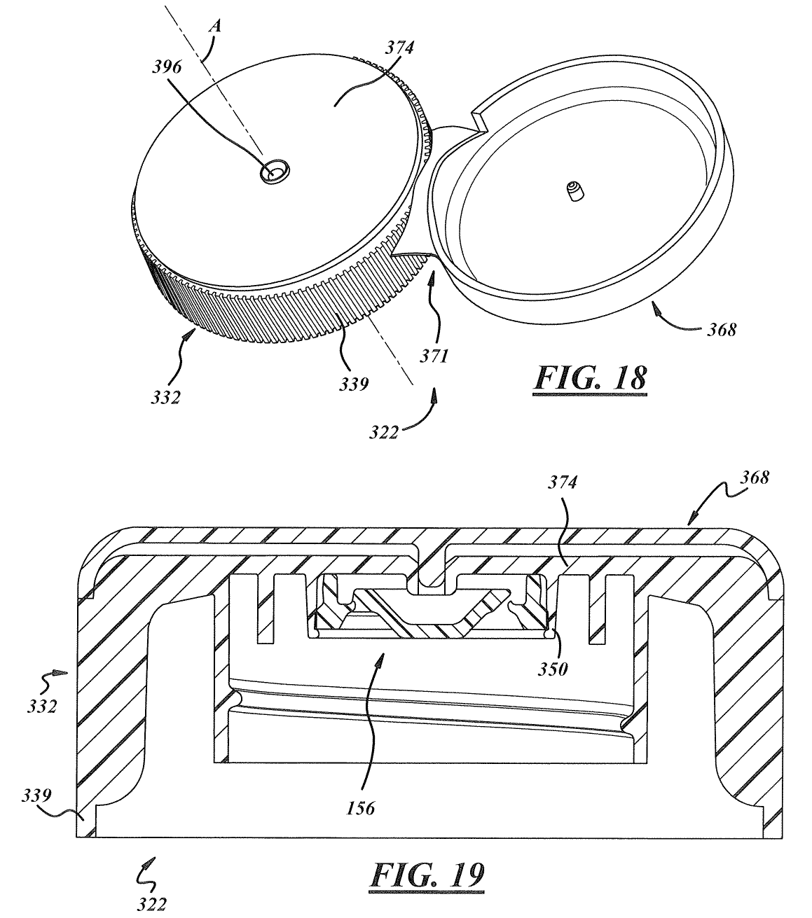

FIGS. 18 and 19 illustrate still another exemplary embodiment of the present disclosure. This embodiment is similar in many respects to the embodiment of FIGS. 1 through 17 and like numerals between the embodiments generally designate like or corresponding elements throughout the several views of the drawing figures. Additionally, the descriptions of the embodiments are incorporated by reference into one another and the common subject matter generally may not be repeated here.

As shown in FIGS. 18 and 19, a closure assembly 322 may include a base 332 and a lid 368 coupled to the base 332, for example, by a hinge 371, which may include, for example, a butterfly type of hinge, or any other suitable closure hinge. The base 332 generally may include an outer skirt 339 that may define a longitudinal axis A of the base 332, and a deck 374 that may extend transversely with respect to the axis A. An outlet orifice 396 may extend through a portion of the deck 374. The lid 368 generally may include a base wall 387 having a plug 394 for plug sealing engagement with the outlet orifice 396 of the base, and a skirt 392 depending generally axially from the base wall 387.

Referring now to FIG. 19, this embodiment is substantially similar to that of FIGS. 16 and 17 except, for example, the deck 374 may be substantially planar such that the sloped wall 242 of FIGS. 16 and 17 are omitted. In any case, the base 332 may further include an inner wall 350 that may be annular and may extend axially from the deck 374 to carry the baffle 153.

There have thus been disclosed a dispensing closure assembly and a dispensing package that fully achieve one or more of the objects and aims previously set forth. The disclosure has been presented in conjunction with several exemplary embodiments, and additional modifications and variations have been discussed. Other modifications and variations readily will suggest themselves to persons of ordinary skill in the art in view of the foregoing discussion. The disclosure is intended to embrace all such modifications and variations as fall within the spirit and broad scope of the appended claims.

1. A dispensing closure assembly that includes:
a deck having an outlet orifice,
an outlet conduit extending through said deck generally coaxially with respect to said outlet orifice,
an inner wall extending generally coaxially with respect to said outlet conduit, wherein a fluid chamber is at least partially defined radially inwardly of said inner wall, and
a baffle wall carried radially inwardly of said inner wall, wherein one or more fluid flow passages are defined between said inner wall and said baffle wall, said baffle wall including a central portion opposed to said outlet conduit and a raised peripheral portion extending axially and radially outwardly from said central portion,
such that fluid flowing through said fluid flow passages enters said fluid chamber through said fluid flow passages, is directed toward said inner wall by said baffle wall, and then flows into said outlet conduit and out said outlet orifice.

2. The dispensing closure assembly set forth in claim 1 wherein said baffle wall is integrally coupled to an inner end of said inner wall.

3. The dispensing closure assembly set forth in claim 2 further comprising:
a closure base including said inner wall and said baffle wall; and
a closure including a collar, which is coupled to said closure base and defines said deck with said outlet orifice.

4. The dispensing closure set forth in claim 1 further comprising:
a closure base including said inner wall, and
a baffle coupled to said closure base and including said baffle wall, an outer wall for engagement with said inner wall, and a plurality of connecting elements connecting said baffle wall to said outer wall to define fluid passages therebetween.

5. The dispensing closure set forth in claim 4 wherein said deck includes a substantially planar and axially oriented plateau, and a sloped portion extending radially outwardly from said plateau.

6. The dispensing closure set forth in claim 5 wherein said deck further includes a rim extending axially from said sloped portion.

7. The dispensing closure set forth in claim 4 wherein said deck is substantially planar.

8. A dispensing closure assembly that includes:
a base having a skirt with a longitudinal axis, an opening remote from said skirt, an inner wall extending inwardly from an inner periphery of said opening, and a baffle wall carried at an inner end of said inner wall and connected to said inner end of said inner wall by connecting elements such that fluid flow passages are formed between said connecting elements, said inner end of said inner wall and an outer periphery of said baffle wall, and
a closure secured to said base and overlying said opening, said closure having a deck overlying said opening, an outlet orifice in said deck, and an outlet conduit extending through said deck inwardly from said outlet orifice and coaxially with said inner wall of said base,
wherein a fluid chamber is at least partially defined radially inwardly of said inner wall, and fluid flowing between said connecting elements enters said fluid chamber and then flows into said outlet conduit and out said outlet orifice.

9. The dispensing closure assembly set forth in claim 8 wherein said outlet conduit is an orifice tube outlet conduit extending from said deck and having an inner end spaced from said baffle wall and having a diameter less than a diameter of said baffle wall.

10. The dispensing closure assembly set forth in claim 9 wherein said baffle wall has an axially depressed central portion and a raised peripheral portion to promote fluid flow from said fluid chamber into said outlet conduit.

11. The dispensing closure assembly set forth in claim 8 wherein said inner wall is conical and tapers radially inwardly.

12. The dispensing closure assembly set forth in claim 8 wherein said base includes a spout at least partially defined by a base wall having said opening, a conical outer wall extending axially inwardly and radially away from said base wall, and an annular wall extending axially outwardly from said base wall and terminating in said opening of said base.

13. The dispensing closure assembly set forth in claim 12 wherein said inner wall forms a continuation of said annular wall.

14. The dispensing closure assembly set forth in claim 12 wherein a chamber is defined between said conical outer wall and said inner wall.

15. The dispensing closure assembly set forth in claim 8 wherein said closure includes a collar coupled to said base and having a sealing wall for sealing engagement with said opening.

16. The dispensing closure assembly set forth in claim 15 wherein said closure further includes a lid coupled to said collar, and wherein said collar includes said deck with said outlet orifice and said lid includes a plug to sealingly engage said collar within said outlet orifice of said collar when said lid is closed.

17. A package including a container and said dispensing closure assembly of claim 8 coupled to said container.

18. A dispensing closure assembly that includes:
a closure base including an opening of said closure base, an outer wall extending axially inwardly and tapering radially outwardly, and an inner wall extending axially inwardly and terminating in an inner end carrying a baffle wall and including fluid flow passages, and
a closure including a collar coupled to said closure base and having a transversely extending deck with an outlet orifice and also having an orifice tube outlet conduit in communication with said outlet orifice and extending axially toward said baffle wall of said closure base and terminating in an open end spaced from said baffle wall, wherein a fluid chamber is defined between said orifice tube outlet conduit and said inner wall of said closure base,
such that product being dispensed flows through said fluid flow passages and enters said fluid chamber before flowing into said orifice tube outlet conduit and out said outlet orifice.

19. The dispensing closure assembly set forth in claim 18 wherein said orifice tube outlet conduit extends greater than half of an axial length of said fluid chamber.

20. The dispensing closure assembly set forth in claim 18 wherein said baffle wall includes a central portion and a raised peripheral portion to direct product toward said inner wall.

21. The dispensing closure assembly set forth in claim 20 wherein said inner end of said inner wall and said raised peripheral portion are angled to provide a lead-in feature to aid in dispensing product.

22. The dispensing closure assembly set forth in claim 18 wherein an inner diameter of said outlet conduit is less than an outer diameter of said baffle wall.

23. The dispensing closure assembly set forth in claim 18 wherein said collar includes an annular sealing wall sealingly engaged to said inner wall of said closure base in said opening thereof.

24. The dispensing closure assembly set forth in claim 18 wherein said closure also includes a lid coupled to said collar and including a plug to sealingly engage said collar within said outlet orifice of said collar when said lid is closed.

25. A package including a container and said dispensing closure assembly of claim 18 coupled to said container.

26. A dispensing closure assembly that includes:
a closure base including a deck having an outlet orifice, an orifice tube outlet conduit extending from said deck generally coaxially with respect to said outlet orifice, and an inner wall extending from said deck generally coaxially with respect to said orifice tube outlet conduit, wherein a fluid chamber is at least partially defined between said orifice tube outlet conduit and said inner wall, and
a baffle coupled to said closure base and including a baffle wall carried radially inwardly of said inner wall, wherein one or more fluid flow passages are defined between said inner wall and said baffle wall, said baffle wall including a central portion opposed to said orifice tube outlet conduit and a raised peripheral portion extending axially and radially outwardly from said central portion,
such that fluid flowing through said fluid flow passages enters said fluid chamber through said fluid flow passages, is directed toward said inner wall by said baffle wall, and then flows into said orifice tube outlet conduit and out said outlet orifice.

27. The dispensing closure assembly of claim 26 wherein said baffle further includes an outer wall fit within said inner wall of said closure base and connected to said baffle wall by a plurality of connecting elements.

28. The dispensing closure assembly set forth in claim 26 wherein said deck includes a substantially planar and axially oriented plateau, and a sloped portion extending radially outwardly from said plateau.

29. The dispensing closure assembly set forth in claim 26 wherein said deck further includes a rim extending axially from said sloped portion.

30. The dispensing closure assembly set forth in claim 26 wherein said deck is substantially planar.
